(19) United States
(12) Patent Application Publication
(10) Pub. No.: US 2007/0143614 A1
(43) Pub. Date: Jun. 21, 2007

(54) Method, system and devices for protection of a communication or session

(75) Inventors: Silke Holtmanns, Vantaa (FI); Nadarajah Asokan, Espoo (FI); Valtteri Niemi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/641,871

(22) Filed: Dec. 20, 2006

(30) Foreign Application Priority Data
Dec. 21, 2005 (EP) 05028049.4

(51) Int. Cl. H04L 9/00

(52) U.S. Cl. 713/171

(57) ABSTRACT

The invention provides a method, system, program and devices such as a user equipment, terminal, smart card, for protection of a communication or session, in particular in an IMS.

The present invention relates in general to communication such as mobile communications, and in particular to method, system and devices for providing protection of a communication or session. The protection can e.g. be established for TLS, Transport Layer Security, usage in a communication system or method. The invention may for example be used in a IP Multimedia Subsystem, IMS, for providing possibilities for protection in IMS. IP stands for Internet Protocol. The invention may also be used for protection in Pre-Shared Key, PSK, TLS usage.

To protect IMS, IPSec, IP Security, Transport Layer Security, TLS, or Pre-Shared Key TLS may be used. The PSK TLS and TLS protocols provide communications privacy over the Internet. The protocol may provide client/server applications to communicate in a way that is designed to prevent eavesdropping, tampering, or message forgery.

In SA3#41 (November 2005), use of a server client token based TLS mechanism has been proposed in IMS S3-050762 (contribution to the Third Generation Partnership Project (3GPP), SA3 Meeting #41, November 2005). One goal of this token mechanism is the prevention of a man-in-the-middle attack of an attacker residing between UE and P-CSCF (Proxy Call Session Control Function). For the server/client token, a target is to authenticate the user or the users device or the users smart card or the users secure platform. AKAv1 (Authentication Key Agreement Protocol version 1 as specified in Request for Comments, RFC 3310, Internet Engineering Task Force (IETF), Niemi, A., Arkko, J., and V. Torvinen, “Hypertext Transfer Protocol (HTTP) Digest Authentication Using Authentication and Key Agreement (AKA)”, September 2002) uses RES to authenticate the user. There a man-in-the-middle-attack can “fool” the User Equipment (UE) to send a response containing the RES. A problem in the usage of AKAv1 with TLS is that after the network got the response from the UE, the network does not know if the following messages are from the same UE. The problem with AKAv1 arises from the fact that cryptographic keys CK and IK are used in different contexts.

If TLS is used, then some additional protection against man-in-the-middle attack is needed. This document describes various protection approaches against man-in-the-middle.

The Server/Client Token (Evolved I-TLS) approach (contribution S3-050762, contribution to the Third Generation Partnership Project (3GPP), SA3 Meeting #41, November 2005) requires TLS profile for TLS based access security. The UE and the P-CSCF support the TLS version as specified in RFC 2246 (TLS Protocol, IETF, T. Dierks, C. Allen, “The TLS Protocol Version 1.0” RFC 2246, January 1999) and WAP-219-TLS [Wireless Application Protocol (WAP), Open Mobile Alliance (OMA), “WAP TLS Profile and Tunneling” http://www.openmobilealliance.org/tech/affiliates/wap/wap -219-tls-20010411-a.pdf] or higher. Earlier versions may cause difficulties. Regarding protection mechanisms, the UE and P-CSCF shall support the CipherSuite TLS_RSA_WITH_{—}3DES_EDE_CBC_SHA and the CipherSuite TLS_RSA_WITH AES_{—}128_CBC_SHA as defined in [RFC 3310]. All other Cipher Suites as defined in RFC 2246 and RFC 3268 are optional for implementation, but also possible. Cipher Suites with NULL encryption may be used. During the TLS handshake phase the UE should offer the TLS Cipher Suites that it supports and is willing to use for encryption. Cipher Suites with NULL integrity protection (or HASH) shall not be allowed.

As to authentication of the P-CSCF, The P-CSCF is authenticated by the Client as specified in WAP-219-TLS, (which in turn is based on RFC 2246) in combination with the s_token (server token). The P-CSCF certificate profile shall be based on WAP (Wireless Application Protocol) Certificate as defined in WAP 211 WAPCert [WAP-OMA, “WAP Certificate Profile and CRL”, http://www.openmobilealliance.org/tech/affiliates/wap/wap -211-wapcert-20010522-a.pdf]. If a PKI (Public Key Infrastructure) is used, additional CRL (Certificate Revocation Lists) profile should be as defined in WAP 211 WAPCert. The P-CSCF's server certificate does not need to be part of any particular PKI for the user to trust it and it can be a self-signed certificate. The only requirement on the certificates is that they are formed according to the general format and that the public key of the server is included properly.

As to authentication of the UE, the P-CSCF shall not request a certificate in a Server Hello Message from the UE. The S-CSCF shall authenticate the UE as specified in clause 6.1.1 of TS33.203 of 3GPP [Technical Specification TS33.203 of 3GPP, http://www.3gpp.org/ftp/Specs/archive/33 series/33.203/].

For providing verification of the TLS tunnel endpoints, in order for the UE to be able to trust the server side certificate, the P-CSCF shall calculate a server authorization token (s_token) over the P-CSCF's server certificate and send this to the UE. The UE shall verify the s_token and thus the UE is able to trust the server side certificate and the corresponding TLS tunnel. The UE in turn shall calculate a client authorization token (c_token) and send this to the P-CSCF. By sending the c_token the UE acknowledges that it received and accepted the s_token. The P-CSCF shall verify the TLS tunnel endpoint of the UE by using the client token (c_token). The P-CSCF's server certificate does not need to be part of any particular PKI for the user to trust it and it can be a self-signed certificate, if the mechanism described in this clause is used. The only requirement on the certificates is that they are formed according to the general format and that the public key of the server is included properly. The UE does not need to verify the CA signature (as this verification is replaced by the s_token). If self-signed certificates are used, Root Certificates are not needed. The s_token shall consist of a MAC value that is calculated over the P-CSCF's server certificate using HMAC-SHA1-96 [RFC2404] [IETF, C. Madsone et al, “The Use of HMAC-SHA-1-96 within ESP and AH” RFC 2404, November 1998] as algorithm and IK_{IM} as the key. The c_token shall consist of a MAC (Message Authentication Code) value that is calculated over the s_token using HMAC-SHA1-96 [RFC2404] as algorithm and IK_{IM} as the key.

The s_token is included as a parameter in the WWW-Authenticate header of 4xx Auth_challenge message (SM6 in FIG. 1) in the similar way as the IK and CK are transported from the S-CSCF (Service CSCF) to P-CSCF in the corresponding WWW-Authenticate header of 4xx Auth_challenge message (SM5 in FIG. 1). The c_token is carried in the Authorization header of the authenticated REGISTER message (SM7 in FIG. 1).

If the UE is re-authenticated by the S-CSCF with a new IMS AKA procedure, the tokens shall be re-calculated and verified using the new IK_{IM}. The UE continues to use the same TLS session after it has been re-authenticated by the S-CSCF.

As to TLS session parameters, the TLS Handshake Protocol negotiates a session, which is identified by a Session ID. The Client and the P-CSCF shall allow for resuming a session. The lifetime of a Session ID is subject to local policies of the UE and the P-CSCF. A recommended lifetime is one hour (or at least more than the re-REGISTRATION time out). The maximum lifetime specified in RFC 2246 is 24 hours.

When the transport layer protocol is UDP, Datagram TLS shall be used.

For TLS based access security, the set-up of the TLS tunnel between the UE and the P-CSCF is based on the TLS profile. The Sec-agree negotiation according to RFC 3329 (Security Mechanism Agreement for the SIP Session Inititation Protocol) is run during the registration procedure to confirm the choice of the security mechanism. In the Annex of specification TS33.203 shows how to use RFC 3329 [IETF, J. Arkko et al “Security Mechanism Agreement for the Session Initiation Protocol (SIP)”, RFC 3329, January 2003] for the set-up of security associations.

FIG. 1 shows message flows between a user equipment, UE, a P-CSCF, Proxy Call State Control Function, and an S-CSCF, Serving Call State Control Function. A normal case is specified i.e. when no failures occurs. Note that for simplicity some of the nodes and messages have been omitted. Hence there are gaps in the numbering of messages, as the I-CSCF, Interrogating Call State Control Function, is omitted.

In FIG. 1, the UE and the P-CSCF set-up a TLS tunnel. The P-CSCF uses server side certificate for the TLS tunnel. This procedure shall be done, either before message SM1 or before SM7 in FIG. 1. To avoid unnecessary computations (and possible user interaction), the UE need not verify the CA (Certificate Authority) signature in the certificate, as it can simply accept the certificate. This is due to the CA certificate verification is replaced by the s_token. All further communication between UE and P-CSCF is sent through this TLS tunnel.

The UE sends a Register message towards the S-CSCF to register the location of the UE and to set-up the security mode. In order to start the security mode set-up procedure, the UE shall include a Security-setup-line in this message. The Security-setup-line in SM1 contains the Security mechanism supported by the UE. The message SM1 is a message REGISTER(Security-setup=TLS). TLS is the symbolic name of the security mechanism name that the UE selects. The syntax of TLS is defined in Annex H of TS33.203.

Upon receipt of the message SM1, the P-CSCF temporarily stores the parameters received in the Security-setup-line together with the UE's IP address from the source IP address of the IP packet header, the IMPI and IMPU. Upon receipt of the message SM4, the P-CSCF adds the keys IK_{IM} and CK_{IM} received from the S-CSCF to the temporarily stored parameters. The P-CSCF calculates the server token (s_token) over the P-CSCF's server certificate using IK_{IM}, and appends the s_token to the SM6 message. In case the TLS tunnel was not set up prio SM1, but prio SM7, the P-CSCF needs to calculate and send the s_token to the UE before the TLS tunnel is set up. The Security-setup-line in message SM6, 4xx Auth_Challenge(s_token, Security-setup=TLS), contains the Security mechanism supported by the P-CSCF. TLS is the symbolic name of the Security mechanism that the P-CSCF selects. The syntax of TLS is defined in Annex H of TS33.203.

Upon receipt of SM6, the UE uses IK_{IM} to validate the s_token, i.e. it calculates a MAC over the server certificate of the TLS tunnel. If the computed MAC equals with the MAC received in the authentication challenge, the UE is able to trust the TLS tunnel. If the MAC verification fails, the procedure is aborted and the TLS tunnel is released. In case the TLS tunnel was not set up prio SM1, but prio SM7, the UE needs to set up the TLS tunnel before processing the s_token in SM6. The s_token verification guarantees that the P-CSCF is trusted by the home network. (If the P-CSCF is not trusted by the home network it will not have access to IK_{IM}). The UE then calculates an authorization verification token (c_token) to acknowledge that it received and accepted the s_token. The c_token is a MAC calculated over the s_token using IK_{IM}

The UE appends the c_token to the SM7 message. Furthermore the Security mechanism received from by P-CSCF shall be included in the SM7 message: REGISTER(c_token, Security-setup=TLS).

After receiving SM7 from the UE, the P-CSCF shall verify the c_token. The P-CSCF shall also check whether the Security mechanisms received in SM7 is identical with the corresponding parameters sent in SM6. It further checks whether Security mechanism received in SM7 was included in SM1. If these checks are not successful the registration procedure is aborted and the TLS tunnel is released. The P-CSCF shall include in SM8 information to the S-CSCF that the received message from the UE was integrity protected as indicated in TS33.203 clause 6. The P-CSCF shall add this information to all subsequent REGISTER messages received from the UE that have successfully passed the integrity and confidentiality check in the P-CSCF. The integrity protection indication parameters in the REGISTER messages shall only be included after that the P-CSCF has verified the c_token correctly. The message SM8 includes: REGISTER(Integrity-Protection=Successful, Confidentiality-Protection=Successful, IMPI).

The P-CSCF finally sends SM12 to the UE. SM12 does not contain information specific to security mode setup (i.e. a Security-setup line), but with sending SM12 not indicating an error the P-CSCF confirms that security mode setup has been successful. After receiving SM12 not indicating an error, the UE can assume the successful completion of the security-mode setup.

In this approach for protecting IMS for the man-in-the-middle attack, no PKI is needed for server certificate validation. The Server and Client Tokens prevent man in the middle attack. However, changes to TLS client and server side are provided to use the token-mechanism to validate the certificate. Changes in the protocol messages are required to transport the tokens and fetch them from the received messages. MAC needs to be send. A calculation of server and client token is needed. All these changes make the success of such a mechanism unlikely.

### SUMMARY OF THE INVENTION

The invention provides a method, system, device such as a network element, computer program product, and semiconductor chip such as a smart card or part of a smart card, as defined in the claims.

Further aspects, advantages and details of the invention will be described in the following.

### BRIEF DESCRIPTION OF THE DRAWINGS

FIG. 1 shows message flows between a user equipment, UE, a P-CSCF, Proxy Call State Control Function, and an S-CSCF, Serving Call State Control Function;

### DETAILED DESCRIPTION OF EMBODIMENTS OF THE INVENTION

In accordance with an embodiment of the invention, TLS and AKA version 2 can be used. AKA version 2 [IETF, V. Torvinen et al, “Hypertext Transfer Protocol (HTTP) Digest Authentication Using Authentication and Key Agreement (AKA) Version-2” RFC 4169, November 2005] can be used for client authentication. TLS for normal protection. AKAv2 prevents the man-in-the-middle attack. This embodiment has the benefit that AKAv2 is standardized, and Man in the Middle Attacks are prevented.

However, AKAv2 specification mentions, in section 4.3 (RFC 4169), comparing the “realm name” with the name of the server authenticated using TLS server authentication. But 3GPP has to specify the “realm name” should contain the server name. This implies changes or additions to IETF AKAv2 specifications. According to RFC 4169, section 3, “an attacker may forward the HTTP Authentication challenge from the proxy/server to the victim. If the victim is not careful, and does not check whether the identity in the server certificate in TLS matches the realm in the HTTP authentication challenge, it may send a new request that carries a valid response to the HTTP Authentication challenge.” Further, changes to P-CSCF and S-CSCF. P-CSCF would need to support TLS and perform the validation. The S-CSCF would need to support AKAv1 and AKAv2. Client side would need to be able to do the checking. This implies many changes to protocols and network nodes.

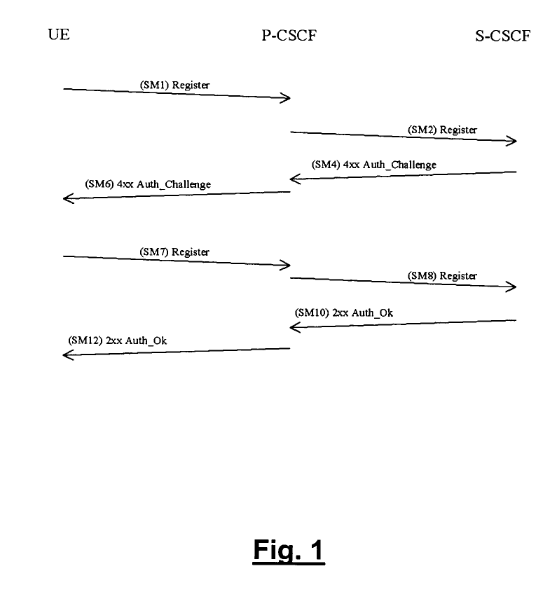

In accordance with another embodiment shown in FIG. 1, TLS server certificates for server authentication and PSK TLS for client authentication may be used. This embodiment has benefits of low impact, easiness of implementation and closeness to the IPSec solution.

The UE and the P-CSCF may set-up a TLS tunnel. The P-CSCF uses server side certificate for the TLS tunnel. This procedure shall be done, either beforemessage SM1 or beforeSM7.

As shown in FIG. 1, the UE sends a message SM1 “Register” to a P-CSCF which sends or forwards the message “Register” to S-CSCF, message SM2. The S-CSCF returns a challenge message SM4, “4xx Auth_Challenge”, to the P-CSCF which is forwarded to the UE as a message SM6.

The UE answers with a message SM7 “Register” which is forwarded to, and checked by, the S-CSCF. If the answer is correct, the S-CSCF returns a message SM10 of

FIG. 1, “2xx Auth_Ok” to the P-CSCF which forwards it to the UE.

In a basic embodiment, the server and client tokens are exchanged in messages SM6 and SM7.

In a specific embodiment of the invention, a TLS tunnel is set up (optionally) between P-CSCF and the UE before sending message SM1. No client or server tokens are exchanged. Server authentication is performed via TLS certificates and PKI. After Step SM6 the client (subscriber, user of UE) continues with PSK TLS for client authentication (mandatory). The client authentication can be done similar to the IPSec case where IP address(es) is used. The client authentication can be based on IP address and knowledge of IK and CK. In this embodiment, only changes in P-CSCF are needed, no changes in S-CSCF. It is easy to implement, since state machine is very similar or equal to the IPSec case. No changes to existing protocol messages are required. No Man in the Middle Attack (no access to CK and IK) possible. No PSK TLS-TLS interoperability problems are introduced by this solution. User privacy protection is ensured via TLS tunnel in the beginning (optional). The PSK-TLS UE implementation is non-IMS specific and can later on also used for other applications. The TLS tunnel set-up can be optional, if privacy protection is desired. PSK TLS and TLS are supported at UE and P-CSCF.

A further embodiment of the invention such as the one shown in FIG. 1 provides a TLS and Key Derivation Function Approach.

If privacy protection is wanted, then a TLS tunnel between UE and P-CSCF is set up before sending the first message SM1 shown in FIG. 1

This approach adds a GBA key (GBA, Generic Bootstrapping architecture) derivation function to the S—CSCF. This key derivation function implements the KDF (Key Derivation Function) as specified in TS 33.220 in the S-CSCF for deriving the Ks_(int/ext)_NAF i.e. (following 4 lines are from Annex B TS33.220 [3GPP, “Generic Bootstrapping Architecture”, TS33.220, http://www.3gpp.org/ftp/Specs/archive/33 series/33.220/]) :

Ks=CK ||IK

Ks_NAF=KDF (Ks, “gba-me”, RAND, IMPI, NAF_Id),

Ks_ext_NAF=KDF (Ks, “gba-me”, RAND, IMPI, NAF_Id), and

Ks_int_NAF=KDF (Ks, “gba-u”, RAND, IMPI, NAF_Id).

Note: the NAF_Id is an application identifier and a protocol (UE-SCSF) identifier.

Also other key derivation functions are possible. The key derivation process and the conversion to CK′, IK′and RES′ in the user equipment can be in a smart card, a trusted platform or in the mobile terminal itself.

A dedicated protocol identifier is needed for the “security enhanced IMS”. But this can be done as a parameter in the IMS protocol version negotiation or by adding a parameter in a message from the S-CSCF e.g. in the WWW-Auth header.

The S-CSCF will set the RES′, IK′ and CK′ using the above mentioned key derivation function. The key derivation defines the RES′, IK′ and CK′. This can be done e.g. according to the following two methods:

(1) RES′=Ks_(int/ext)_NAF, or

(2) IK′||CK′=Ks_(int/ext)_NAF. (|| concatenation).

These two methods (1) and (2) can be used in the following ways:

Above methods (1) and (2) are both done, but then IK′and CK′ are used once, already.

Only (1) is done, and then use KDF again (e.g. with different input parameter P0, currently it is gba_u or gba_me, see Annex B of TS 33.220) for IK′ and CK′ e.g. derived key=HMAC-SHA-256 (Key, S) with S=FC||P0||L0||P1||L1||P2||L2||P3||L3|| . . . ||Pn||Ln and either P0 is a new string or one additional Pn string with length Ln is added. The string can indicate the usage in the IMS system or the protocol within the CK′, IK′, RES′ are used e.g. IPSec, TLS, PSK TLS.

Or only (2) is done, and then a separate key derivation function KDF is used for deriving the RES′. Again KDF with different input parameter can be used, as described in (b).

After the derivation of the key the S-CSCF will send the IK′, CK′ and the RES′ to the P-CSCF. The UE has to perform the same key derivations as the S-CSCF. And the IK′, CK′ and RES′ can be used then by the UE and the P-CSCF. IK′ and CK′ can also be used in several ways, including how IK and CK are used in current IMS. In other words:

IK′ and CK′ can be used for IPsec (as IK and CK),

IK′ and CK′ can be used for PSK TLS as outlined by TS33.222 [3GPP, “Access to network application functions using Hypertext; 3GPP, “Transfer Protocol over Transport Layer Security (HTTPS)”, TS33.222,http://www.3gpp.org/ftp/Specs/archive/33_series/33.222/] (as IK and CK),
IK′ and CK′ are not used at all, but instead server-authenticated TLS is used for IMS protection (with the benefit that there is no man in the middle attack).

The key derivation function and the conversion of the output data to RES′, CK′ and IK′ are essentially a replacement for the AKAv2 key derivation function. The advantage is that key derivation can be re-used to implement full-fledged GBA later, unlike the AKAv2 KDF. That has to be as an extra implementation and is not reused for other applications. The UE can not be fooled to use RES′ outside the TLS tunnel. This embodiment provides benefits in that the 3GPP specifications can be reused i.e. KDF. No need to add something to “external specifications”. Only TS 33.220 needs small additions. No AKAv2 is needed, but approach similar to AKAv2. Man in the middle attacks can be avoided when it is used with TLS. Also interleaving attacks can be avoided. No implementation change to HSS (Home Subscriber System) and P-CSCF is needed.

S-CSCF has an added key derivation function. P-CSCF is able to receive CK′ and IK′ (but this is the same as for CK and IK). So no change for the P-CSCF is needed. Vanilla AKAv1 or this AKAv1 in combination with the GBA-KDF can e.g. be used (AKAv2 has already reserved a new algorithm name with IANA). This might be done as part of the IMS version negotiation, but might require some new info to be transported in the protocol. But this has no impact on the actual key derivation and the derivation of CK′, IK′ and RES′.

This embodiment of the invention using the TLS and Key Derivation Function approach is a new IMS security solution which can re-use existing 3GPP component (i.e. GBA KDF), and has a low implementation impact. Especially, when used in conjunction with other services the re-usage of GBA also for this security approach reduces the overall costs.

Although preferred embodiments have been described above, the present invention is not limited thereto and intends to cover also all modifications, amendments, additions and deletions of features within the abilities of a person skilled in the art.

1. Method for providing security of a communication or session, comprising
applying a key derivation function; and
using keys resulting from the key derivation function.

2. Method according to claim 1, wherein, Transport Layer Security (TLS), Pre-Shared Key TLS (PSK-TLS), or IPsec is provided.

3. Method according to claim 1, wherein the key derivation function is an application-specific key derivation function.

4. Method according to claim 1, wherein the key derivation function is a key derivation function for IP Multimedia Subsystem (IMS).

5. Method according to claim 1, wherein the key derivation function is a key derivation function as specified in Generic Bootstrapping Architecture (GBA).

6. Method according to claim 1, wherein the keys resulting from applying the key derivation function are used with at least one of Pre-Shared Key Transport Layer Security (PSK-TLS), IPsec, server-authenticated TLS.

7. Method according to claim 1, wherein a Transport Layer Security (TLS) tunnel between user equipment (UE) and a proxy call state control function (P-CSCF) is set up before sending a first message from UE to P-CSCF.

8. Method according to claim 1, wherein the key derivation function (KDF) is added to a serving call state control function, S-CSCF.

9. Method according to claim 1, wherein a key derivation provided by the key derivation function (KDF) defines parameters such as RES′, IK′ and CK′.

10. Method according to claim 9, wherein a serving call state control function (S-CSCF) sets the parameters RES′, IK′ and CK′.

11. Method according to claim 1, wherein a key derivation provided by the key derivation function (KDF) defines parameters such as RES′, IK′ and CK′, according at least one of the following methods:
(1) RES′=Ks_(int/ext)_NAF, or
(2) IK′||CK′=Ks_(int/ext)_NAF. (wherein || designates concatenation).

12. Method according to claim 11, wherein both methods (1) and (2) are done; or only (1) is done, and then KDF is used again; or only (2) is done, and then a separate key derivation function is used for deriving the RES′.

13. Method according to claim 11, wherein after the derivation of the key, a serving call state control function (S-CSCF) sends parameters including the IK′, CK′and the RES′ to a proxy call state control function (P-CSCF).

14. Method according to claim 11, wherein a user equipment (UE) performs the same key derivations as a serving call state control function (S-CSCF).

15. Method according to claim 1, wherein at least one of a key derivation provided by the key derivation function, and a parameter setting of at least one of parameters CK′, IK′ and RES′ are performed in a terminal, a trusted platform, or a smart card.

16. Method according to claim 1, wherein a user equipment (UE) generates a register message which is sent to a serving call state control function (S-CSCF), the S-CSCF generates a challenge message which is sent to the UE, and the UE answers with a message that is checked by the S-CSCF for correctness.

17. Method for providing security of a communication or session, comprising:
performing a server authentication using TLS, Transport Layer Security, certificates, and then
performing a client authentication using Transport Layer Security (TLS), Pre-Shared Keys, (PSK), or IPSec.

18. Method according to claim 17, wherein the client authentication is performed using keys including CK′, IK′and RES′ derived by a key derivation function.

19. Method according to claim 1, wherein server and client tokens are exchanged in messages between a proxy call state control function (P-CSCF) and user equipment (UE).

20. Method according to claim 1, wherein Transport Layer Security (TLS) server certificates for server authentication and Pre-Shared Key TLS (PSK TLS) for client authentication are used.

21. System comprising:
means for applying a key derivation function; and
means for using keys resulting from the key derivation function.

22. Device configured to:
apply a key derivation function; and
use keys resulting from the key derivation function.

23. Device according to claim 22, wherein the device is a user equipment, a call state control function, a semiconductor chip, or a smart card storing a program.

24. Computer program product embodied on a computer-readable medium configured to
apply a key derivation function; and
use keys resulting from the key derivation function.
